(19) United States
(12) Patent Application Publication
(10) Pub. No.: US 2015/0285437 A1
(43) Pub. Date: Oct. 8, 2015

(54) CONTROL DEVICE FOR VEHICLE AND VEHICLE INCLUDING THE SAME

(71) Applicant: Takumi Anzawa, Okazaki-shi (JP)

(72) Inventor: Takumi Anzawa, Okazaki-shi (JP)

(73) Assignee: TOYOTA JIDOSHA KABUSHIKI KAISHA, Toyota-shi, Aichi-ken (JP)

(21) Appl. No.: 14/440,379

(22) PCT Filed: Sep. 30, 2013
(86) PCT No.: PCT/JP2013/076500

§ 371 Date: May 4, 2015

(30) Foreign Application Priority Data
Nov. 20, 2012 (JP) 2012-254193

(51) Int. Cl. F16N 29/02; F16N 31/00

(52) U.S. Cl. CPC F16N 29/02; F16N 31/006; Y10S 903/903

(57) ABSTRACT

An object of the present invention is to provide a control device for a vehicle which enables prompt warm-up, and a vehicle including the same. When a control state of the vehicle is a started state (Ready-ON state), a float valve disconnects a first oil pan from a second oil pan in any of cases where an engine is in an operational state and in a stopped state, and, when the control state of the vehicle is a stopped state (Ready-OFF state), the float valve provides communication between the first oil pan and the second oil pan.

### TECHNICAL FIELD

The present invention relates to a control device for a vehicle, and a vehicle including the same. More particularly, the present invention relates to a control device for an internal combustion engine lubricated with oil, and a vehicle including the same.

### BACKGROUND ART

Conventionally, control devices for an internal combustion engine have been disclosed for example in Japanese Patent Laying-Open No. 2009-13820 (PTD 1), Japanese Patent Laying-Open No. 2011-117413 (PTD 2), and Japanese Patent Laying-Open No. 2012-111366 (PTD 3).

PTD 1 discloses a vehicle having a first oil pan and a second oil pan, wherein only the first oil pan is used while an engine is in operation, and communication between the first oil pan and the second oil pan is provided by an actuator to exchange oil while the engine is stopped.

PTD 2 discloses a configuration having a first oil pan for lubricating a transaxle and a second oil pan for lubricating an internal combustion engine, wherein common oil is used as oil circulating through the oil pans.

PTD 3 discloses a configuration including a plurality of oil pans provided independently, wherein oil collected in each oil pan can be circulated appropriately.

### CITATION LIST

### Patent Document

PTD 1: Japanese Patent Laying-Open No. 2009-13820

PTD 2: Japanese Patent Laying-Open No 2011-117413

PTD 3: Japanese Patent Laying-Open No 2012-111366

### SUMMARY OF INVENTION

### Technical Problem

In a conventional structure, however, when intermittent stop in which engine start and engine stop are repeated is performed, oil exchange is frequently performed between the first oil pan and the second oil pan, which may cause that the oil cannot be warmed up promptly at the next engine start.

Accordingly, the present invention has been made to solve the aforementioned problem, and an object of the present invention is to provide a control device for a vehicle which enables prompt warm-up, and a vehicle including the same.

### Solution to Problem

A control device for a vehicle in accordance with the present invention is a control device for a vehicle including an internal combustion engine, the internal combustion engine including a first oil pan storing oil which lubricates the internal combustion engine, a second oil pan storing the oil which lubricates the internal combustion engine, and a communication portion capable of providing communication between the first oil pan and the second oil pan, wherein, when a control state of the vehicle is a started state, the communication portion disconnects the first oil pan from the second oil pan in any of cases where the internal combustion engine is in an operational state and in a stopped state, and, when the control state of the vehicle is a stopped state, the communication portion provides communication between the first oil pan and the second oil pan.

In the control device for the vehicle configured as described above, as long as the control state of the vehicle is the started state, the communication portion disconnects the first oil pan from the second oil pan in any of the cases where the internal combustion engine is in the operational state and in the stopped state. Therefore, when the control state of the vehicle is the started state, the internal combustion engine is lubricated with only the oil within the second oil pan. As a result, warm-up can be promptly terminated, when compared with a case where the internal combustion engine is lubricated with both oils within the first and second oil pans.

Further, when the control state of the vehicle is the stopped state, the first oil pan and the second oil pan are in communication with each other, and thus deterioration of the oil can be prevented.

Preferably, the vehicle includes a rotating electrical machine.

Preferably, the communication portion includes a float valve provided between the first oil pan and the second oil pan.

Preferably, the control device further includes an actuator driving the float valve.

A vehicle in accordance with the present invention includes any control device for an internal combustion engine described above.

### BRIEF DESCRIPTION OF DRAWINGS

FIG. 1 is a block diagram showing a configuration of a vehicle having an oil pan controlled by a control device in accordance with Embodiment 1 of the present invention.

FIG. 2 is a cross sectional view showing the oil pan having a double-layered structure for lubricating an engine in FIG. 1.

FIG. 3 is a flowchart illustrating processing of an ECU 300 in the vehicle in accordance with Embodiment 1.

FIG. 4 is a block diagram showing a configuration of a vehicle having an oil pan controlled by a control device in accordance with Embodiment 2 of the present invention.

FIG. 5 is a block diagram showing a configuration of a vehicle having an oil pan controlled by a control device in accordance with Embodiment 3 of the present invention.

FIG. 6 is a block diagram showing a configuration of a vehicle having an oil pan controlled by a control device in accordance with Embodiment 4 of the present invention.

FIG. 7 is a block diagram showing a configuration of a vehicle having an oil pan controlled by a control device in accordance with Embodiment 5 of the present invention.

### DESCRIPTION OF EMBODIMENTS

Hereinafter, a control device for an internal combustion engine and a vehicle using the same in each embodiment based on the present invention will be described with reference to the drawings. It is noted that, when the number, amount, or the like is referred to in the embodiments described below, the scope of the present invention is not necessarily limited to such a number, amount, or the like, unless otherwise specified. Further, identical or corresponding parts will be designated by the same reference numerals, and an overlapping description may not be repeated.

### Embodiment 1

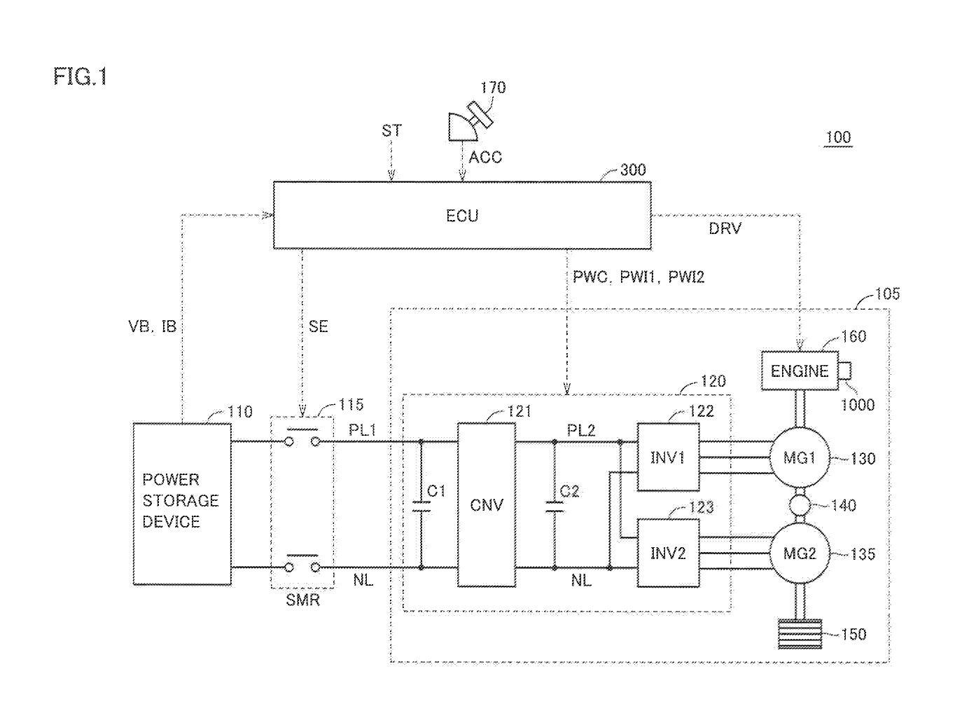

FIG. 1 is a block diagram of a configuration of a vehicle having an oil pan controlled by a control device in accordance with Embodiment 1 of the present invention. Referring to FIG. 1, a vehicle 100 includes a drive device 105, a power storage device 110, a system main relay (hereinafter referred to as an “SMR”) 115, an accelerator pedal 170, and an electronic control unit (hereinafter referred to as an “ECU”) 300.

Drive device 105 includes a power control unit (hereinafter referred to as a “PCU”) 120, motor generators 130, 135, a motive power transmission gear 140, drive wheels 150, and an engine 160. PCU 120 includes a converter 121, inverters 122, 123, and capacitors C1, C2.

Power storage device 110 is a rechargeable direct current (DC) power source, and is composed of, for example, a secondary battery such as a lithium ion battery, a nickel hydride battery, or a lead acid battery. Power storage device 110 is electrically connected to PCU 120 in drive device 105 via power lines PL1, NL, and supplies electric power for generating a drive force of vehicle 100 to PCU 120. Power storage device 110 also stores electric power generated by motor generators 130, 135. Instead of the secondary battery, a power storage element such as an electric double layer capacitor can also be adopted as power storage device 110.

SMR 115 is provided between power storage device 110 and PCU 120 to switch between supply and disconnection of electric power between power storage device 110 and PCU 120 based on a control signal SE from ECU 300. Converter 121 performs voltage conversion between power lines PL1, NL and power lines PL2, NL based on a control signal PWC from ECU 300.

Inverters 122, 123 are connected to power lines PL2, NL in parallel. Inverters 122, 123 convert DC power supplied from converter 121 into alternating current (AC) power and drive motor generators 130 and 135, respectively, based on control signals PWI1 and PWI2, respectively, from ECU 300.

Capacitor C1 is electrically connected between power lines PL1 and NL to reduce an AC component of voltage fluctuation between power lines PL1 and NL. In addition, capacitor C2 is electrically connected between power lines PL2 and NL to reduce an AC component of voltage fluctuation between power lines PL2 and NL.

Motor generators 130, 135 are each an AC rotating electrical machine, and composed of, for example, a permanent magnet synchronous motor including a rotor having a permanent magnet embedded therein. Output torques of motor generators 130, 135 are transmitted to drive wheels 150 via motive power transmission gear 140 to cause vehicle 100 to travel. Motive power transmission gear 140 includes a reduction gear and a motive power split device represented by a planetary gear. In addition, at the time of a braking operation of vehicle 100, motor generators 130, 135 can generate electric power by receiving a rotational force of drive wheels 150. The generated electric power is converted by PCU 120 into charging power for power storage device 110.

Motor generators 130, 135 are coupled to engine 160 via motive power transmission gear 140. Engine 160 is controlled by a control signal DRV from ECU 300. Then, motor generators 130, 135 and engine 160 are cooperatively controlled by ECU 300 to generate a required vehicle drive force. Further, motor generators 130, 135 can generate electric power by the rotation of engine 160 or the rotation of drive wheels 150, and can charge power storage device 110 using the generated electric power. In Embodiment 1, motor generator 135 is exclusively used as a motor for driving drive wheels 150, and motor generator 130 is exclusively used as a generator driven by engine 160.

Motor generator 130 (MG1) has a rotation shaft coupled to a sun gear of the planetary gear (not shown) included in motive power transmission gear 140. Motor generator 135 (MG2) has a rotation shaft coupled to a ring gear of the planetary gear via the reduction gear. Engine 160 has an output shaft coupled to a planetary carrier of the planetary gear. By adopting such a coupled state, motive power transmission gear 140 also functions as a continuously variable transmission. It is noted that, although not shown in FIG. 1, an additional transmission may be provided within drive device 105.

Accelerator pedal 170 is operated by a driver, and outputs an operation amount ACC (hereinafter also referred to as an “accelerator position”) thereof to ECU 300. Basically, ECU 300 controls a drive force to be generated by drive device 105, based on accelerator position ACC. Then, ECU 300 controls motor generators 130, 135 and engine 160, in accordance with required power and a vehicle speed based on the operation amount of accelerator pedal 170, the state of charge (also referred to as the “SOC”) of power storage device 110, and the like.

ECU 300 includes a CPU (Central Processing Unit), a storage device, and an input/output buffer (all not shown). ECU 300 receives a signal from each sensor or the like and outputs a control signal to each device, as well as controls vehicle 100 and each device. It is noted that these controls can be processed not only by software but also by exclusive hardware (electronic circuitry).

Further, ECU 300 obtains a start request signal ST indicating a request to start the system of vehicle 100. The request to start the system is a request for setting a control state of a drive system of vehicle 100 including drive device 105 (hereinafter simply referred to as a “vehicle system”) to a started state (hereinafter referred to as a “Ready-ON state”) Start request signal ST is generated by the operation of a start switch, an ignition key, or the like by the driver.

It is noted that, when the start switch, the ignition key, or the like is operated in the Ready-ON state, a request to stop the system of vehicle 100 is made. The request to stop the system is a request for setting the control state of the vehicle system to a stopped state (hereinafter referred to as a “Ready-OFF state”). ECU 300 switches the control state of the vehicle system between the Ready-ON state and the Ready-OFF state described above.

In the Ready-ON state, ECU 300 permits generation of the drive force from drive device 105 in accordance with the operation of the accelerator pedal by the driver. Specifically, in the Ready-ON state, SMR 115 is closed, and PCU 120 is set to be ready for operation (controlling motor generators 130, 135). Further, in the Ready-ON state, other devices not shown are also set to be ready for operation.

On the other hand, in the Ready-OFF state, ECU 300 does not permit generation of the drive force from drive device 105 in accordance with the operation of the accelerator pedal by the driver. Specifically, in the Ready-OFF state, the operation of PCU 120 is stopped, and engine 160 is also set to the stopped state. Accordingly, in the Ready-OFF state, the drive force is not generated even if the driver operates accelerator pedal 170.

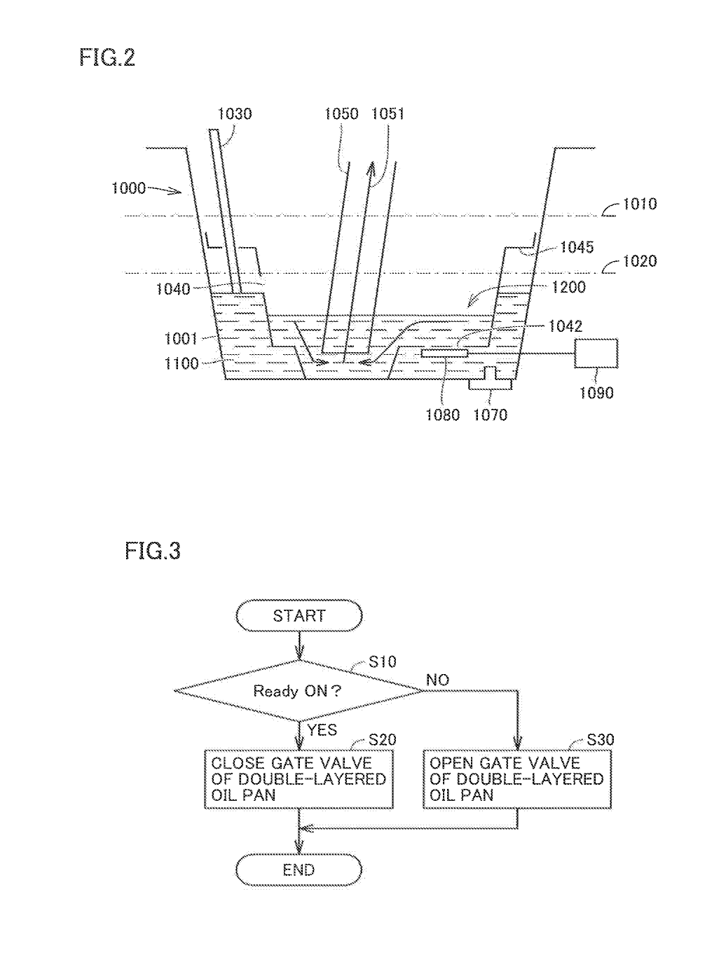

FIG. 2 is a cross sectional view showing the oil pan having a double-layered structure for lubricating the engine in FIG. 1. Referring to FIG. 2, an oil pan 1000 is provided below the engine to store oil which lubricates each component within the engine. The oil pan is a double-layered oil pan having a first oil pan 1100 and a second oil pan 1200.

First oil pan 1100 is provided on the outer side of second oil pan 1200 to surround second oil pan 1200. First oil pan 1100 is provided with a drain plug 1070, and oil 1001 within first oil pan 1100 can be drained by removing drain plug 1070. A level gauge 1030 is inserted in first oil pan 1100.

Second oil pan 1200 is provided within first oil pan 1100 to store oil 1001. An oil suction portion 1050 is arranged at second oil pan 1200, and the oil within second oil pan 1200 is sucked by oil suction portion 1050 in a direction indicated by an arrow 1051. The sucked oil lubricates the engine, and is returned back to second oil pan 1200.

A partition wall 1045 which separates first oil pan 1100 from second oil pan 1200 are provided with communication holes 1040, 1042. Communication hole 1040 is provided at an upper part, and specifically is provided immediately below a LOW oil level 1020. Communication hole 1042 is provided further below communication hole 1040. Communication hole 1042 can be opened/closed by a float valve 1080. Float valve 1080 is controlled by an actuator 1090.

Oil 1001 is poured into oil pan 1000 such that its oil level is located between a FULL oil level 1010 and LOW oil level 1020. First oil pan 1100 as an outer tub and second oil pan 1200 as an inner tub are always in communication with each other via communication hole 1040, and when the oil level is located above communication hole 1040, the oil level in first oil pan 1100 is equal to the oil level in second oil pan 1200.

FIG. 3 is a flowchart illustrating processing of ECU 300 in the vehicle in accordance with Embodiment 1. It is noted that the processing in the flowchart is invoked from a main routine and performed at regular time intervals or whenever predetermined conditions are satisfied. The processing can also be performed by exclusive hardware (electronic circuitry), for some or all of the steps.

Referring to FIG. 3, ECU 300 determines whether or not the control state of the vehicle system is the Ready-ON state (step S10). When ECU 300 determines in step S10 that the control state of the vehicle system is the Ready-ON state (YES in step S10), ECU 300 transmits a signal to actuator 1090 to close float valve (gate valve) 1080. Thereby, float valve 1080 is closed. As a result, only the oil within second oil pan 1200 lubricates engine 160.

When ECU 300 determines in step S10 that the control state of the vehicle system is not the Ready-ON state, that is, the Ready-OFF state (NO in step S10), ECU 300 transmits a signal to actuator 1090 to open float valve 1080. Thereby, float valve 1080 is opened. As a result, oil 1001 within first oil pan 1100 and oil 1001 within second oil pan 1200 are mixed.

Specifically, engine 160 as an internal combustion engine includes first oil pan 1100 and second oil pan 1200 for storing oil 1001, and float valve 1080 as a communication portion capable of providing communication between first oil pan 1100 and second oil pan 1200, oil 1001 being supplied from second oil pan 1200 to engine 160. When the control state of vehicle 100 is a started state (Ready-ON state), float valve 1080 disconnects first oil pan 1100 from second oil pan 1200 in any of cases where engine 160 is in an operational state and in a stopped state, and when the control state of vehicle 100 is a stopped state (Ready-OFF state), float valve 1080 provides communication between first oil pan 1100 and second oil pan 1200.

According to the control device for the vehicle configured as described above, in the Ready-OFF state, oil 1001 within first oil pan 1100 and oil 1001 within second oil pan 1200 can be mixed by providing communication between first oil pan 1100 and second oil pan 1200, and thus deterioration of the oil can be prevented.

In the Ready-ON state, oil 1001 within first oil pan 1100 and oil 1001 within second oil pan 1200 are not mixed even at the time of intermittent stop, by disconnecting first oil pan 1100 from second oil pan 1200. As a result, oil 1001 can be warmed at the time of engine start, and warm-up can be promptly completed.

### Embodiment 2

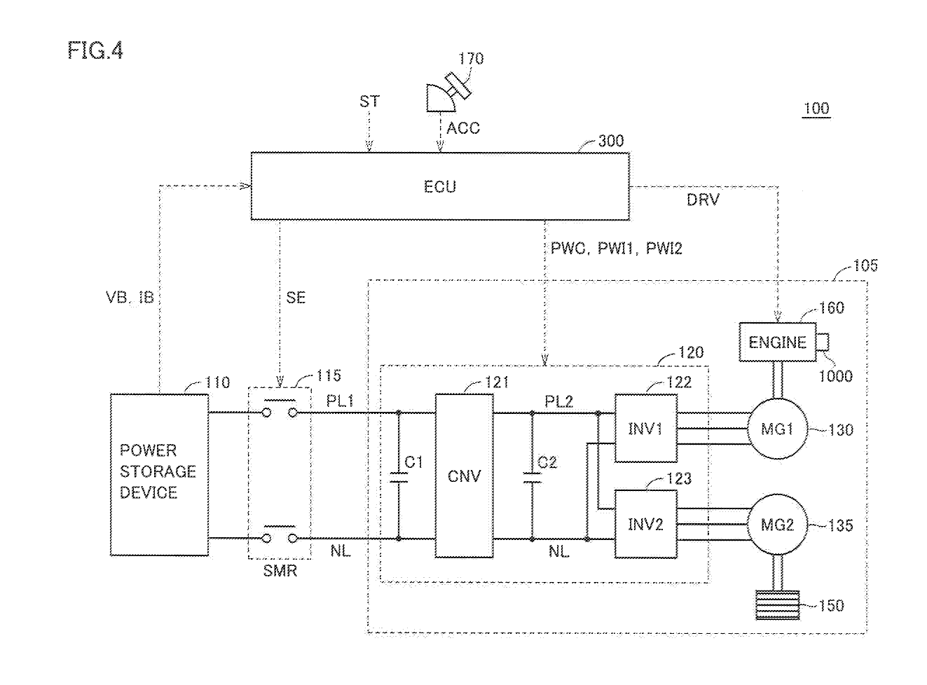

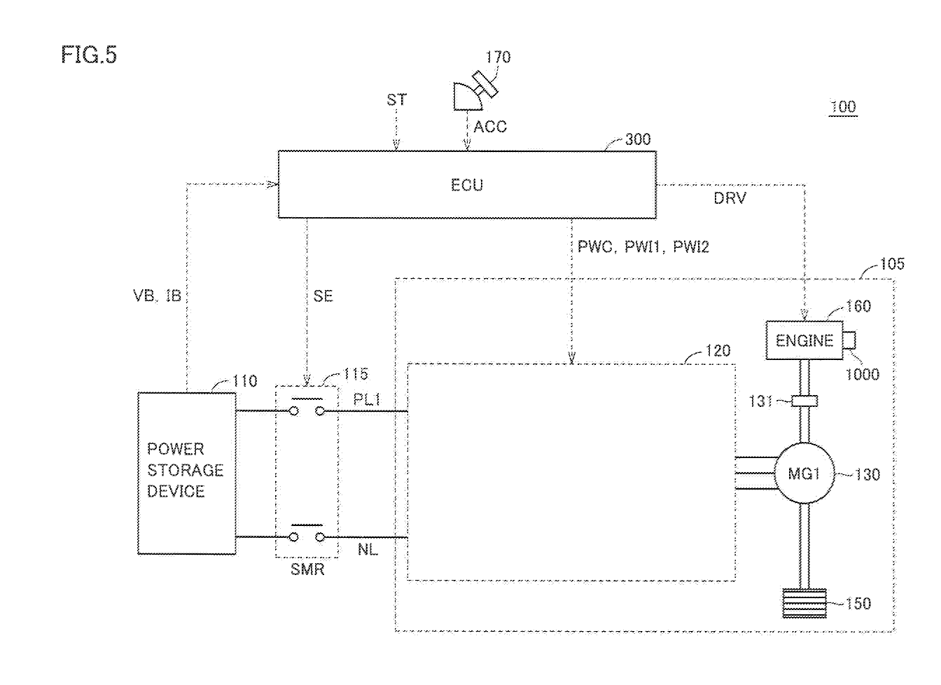

FIG. 4 is a block diagram showing a configuration of a vehicle having an oil pan controlled by a control device in accordance with Embodiment 2 of the present invention. Referring to FIG. 4, vehicle 100 in accordance with Embodiment 2 is different from vehicle 100 in accordance with Embodiment 1 in that motor generator 130 is not mechanically connected with motor generator 135.

Motive power generated by engine 160 is transmitted to motor generator 130, and motor generator 130 performs electric power generation only. The generated electric power is stored in power storage device 110. Motor generator 135 is driven using the electric power. Accordingly, the vehicle in accordance with Embodiment 2 is a series-type hybrid vehicle. In order to lubricate engine 160, oil pan 1000 shown in FIG. 2 is provided, and the control shown in FIG. 3 is performed.

The vehicle configured as described above has the same effect as that in the vehicle in accordance with Embodiment 1.

### Embodiment 3

FIG. 5 is a block diagram showing a configuration of a vehicle having an oil pan controlled by a control device in accordance with Embodiment 3 of the present invention. Referring to FIG. 5, vehicle 100 in accordance with Embodiment 3 is different from vehicle 100 in accordance with Embodiment 1 in that only one motor generator 130 is provided and motor generator 135 is not provided. A clutch 131 is provided between motor generator 130 and engine 160, and can perform connection and disconnection of motive power transmission between engine 160 and motor generator 130. It is noted that clutch 131 does not have to be provided. In order to lubricate engine 160, oil pan 1000 shown in FIG. 2 is provided, and the control shown in FIG. 3 is performed. The vehicle configured as described above has the same effect as that in the vehicle in accordance with Embodiment 1.

### Embodiment 4

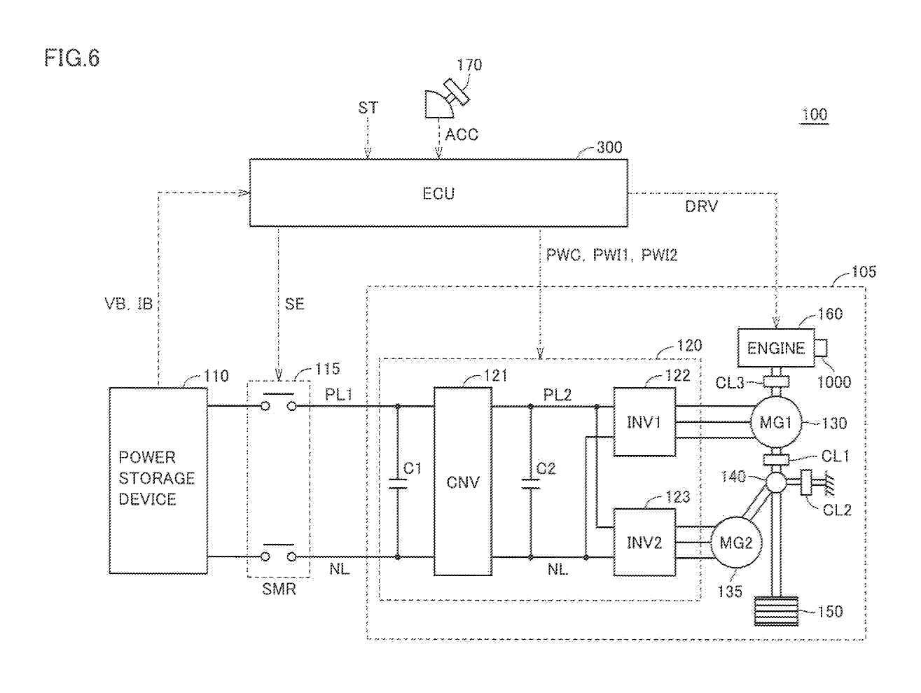

FIG. 6 is a block diagram showing a configuration of a vehicle having an oil pan controlled by a control device in accordance with Embodiment 4 of the present invention. Referring to FIG. 6, vehicle 100 in accordance with Embodiment 4 is different from the vehicle in accordance with Embodiment 1 in that a clutch CL1 is provided between motor generator 130 and motor generator 135, and a clutch CL2 serving as a brake is provided to a ring gear of motive power transmission gear 140.

Motive power transmission gear 140 is configured to include a planetary gear. The planetary gear has a ring gear connected to clutch CL1 and clutch CL2, a planetary carrier connected to drive wheels 150 with a reduction gear interposed therebetween, and a sun gear connected to an output shaft of motor generator 135.

At the time of charging, a clutch CL3 is engaged. Electric power is generated by motor generator 130 using engine 160, and the electric power is stored in power storage device 110.

At the time of EV (electric vehicle) traveling using one motor generator, only clutch CL1 is engaged. By rotating motor generator 135 in this state, the rotation of motor generator 135 is slowed down using motive power transmission gear 140, to rotate drive wheels 150.

At the time of EV traveling using two motor generators, clutch CL2 is engaged. Outputs of motor generators 130, 135 are collected to motive power transmission gear 140, and the planetary carrier rotates drive wheels 150.

At the time of series HV (hybrid) traveling, clutches CL1 and CL3 are engaged Engine 160 is driven to generate electric power in motor generator 130. By rotating motor generator 135 in this state, the rotation of motor generator 135 is slowed down using motive power transmission gear 140, to rotate drive wheels 150.

At the time of series parallel HV traveling, clutches CL2 and CL3 are engaged. Engine 160 is driven to generate electric power in motor generator 130. Further, a portion of the drive force of engine 160 is transmitted to motive power transmission gear 140, and the motive power of engine 160 and the motive power of motor generator 135 rotate drive wheels 150.

The vehicle configured as described above also has the same effect as that in the vehicle in accordance with Embodiment 1.

### Embodiment 5

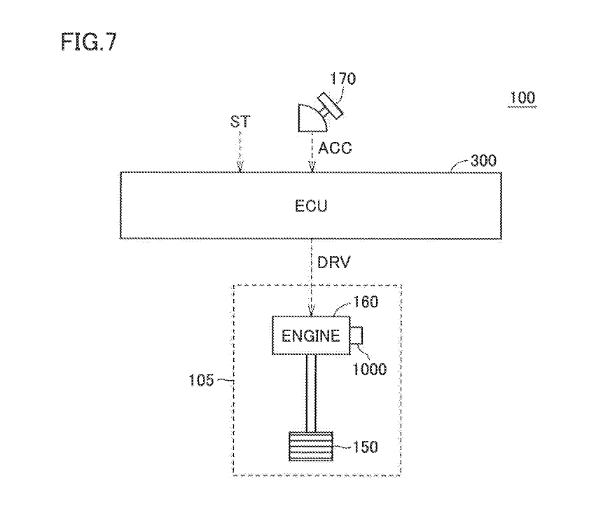

FIG. 7 is a block diagram showing a configuration of a vehicle having an oil pan controlled by a control device in accordance with Embodiment 5 of the present invention.

Vehicle 100 in accordance with Embodiment 5 does not include the motor generators, the power storage device, and the like used in Embodiments 1 to 4. ECU 300 transmits a signal to engine 160 such that engine 160 is stopped when the vehicle is stopped or the vehicle speed is less than or equal to a predetermined speed. Specifically, vehicle 100 in accordance with Embodiment 5 is a vehicle having an idling stop function.

ECU 300 receives a signal regarding the vehicle speed from a vehicle speed sensor. When the vehicle speed is 0 or less than or equal to a predetermined value, ECU 300 stops driving of engine 160. Specifically, in the Ready-ON state, engine 160 is stopped intermittently.

Oil pan 1000 shown in FIG. 2 is provided, and oil pan 1000 is controlled in accordance with the flowchart shown in FIG. 3. Accordingly, in the Ready-ON state, only oil 1001 within second oil pan 1200 is used for lubrication, because first oil pan 1100 is separated from second oil pan 1200. As a result, since oil 1001 within first oil pan 1100 is not mixed into second oil pan 1200, a decrease in the temperature of the oil within second oil pan 1200 can be prevented, and thus warm-up can be promptly completed at the time of engine start.

Although the embodiments of the present invention have been described above, the embodiments described herein can be modified in various manners. First, connection between motor generators 130, 135 and engine 160 is not limited to the above examples, and various connection forms can be adopted.

Further, although vehicle 100 having an idling stop function has been described as an example of vehicle 100 not equipped with a motor generator in Embodiment 5, the present invention is not limited thereto, and is also applicable to a vehicle in which engine 160 is stopped intermittently in the Ready-ON state, for example, a vehicle in which engine 160 is stopped when the vehicle speed is high.

It should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

### INDUSTRIAL APPLICABILITY

The present invention is applicable in the field of a control device for a vehicle, in particular a vehicle having an internal combustion engine lubricated with oil.

### REFERENCE SIGNS LIST

100: vehicle; 105: drive device; 110: power storage device; 121: converter; 122, 123: inverter; 130, 135: motor generator; 140: motive power transmission gear, 150: drive wheel; 160: engine; 170: accelerator pedal; 1000: oil pan; 1001: oil; 1030: level gauge; 1040: communication hole; 1045: partition wall; 1070: drain plug; 1080: float valve; 1090: actuator; 1100: first oil pan; 1200: second oil pan.

1. A control device for a vehicle including an internal combustion engine,
said internal combustion engine comprising first and second oil pans for storing oil, and a communication portion capable of providing communication between said first oil pan and said second oil pan, the oil being supplied from said second oil pan to said internal combustion engine, wherein
when a control state of said vehicle is a started state, said communication portion disconnects said first oil pan from said second oil pan in any of cases where said internal combustion engine is in an operational state and in a stopped state, and
when said control state of said vehicle is a stopped state, said communication portion provides communication between said first oil pan and said second oil pan.

2. The control device for the vehicle according to claim 1, wherein said vehicle includes a rotating electrical machine.

3. The control device for the vehicle according to claim 1, wherein said communication portion includes a float valve provided between said first oil pan and said second oil pan.

4. The control device for the vehicle according to claim 3, further comprising an actuator driving said float valve.

5. A vehicle comprising said control device for the vehicle according to claim 1.
